(19) United States
(12) Patent Application Publication
(10) Pub. No.: US 2019/0091838 A1
(43) Pub. Date: Mar. 28, 2019

(54) RATCHET WRENCH

(71) Applicants: CHUN-WEI YANG, Zhe Jiang (CN); ZHE-PING ZHANG, Long you County (CN)

(72) Inventors: CHUN-WEI YANG, Zhe Jiang (CN); ZHE-PING ZHANG, Long you County (CN)

(21) Appl. No.: 15/712,136

(22) Filed: Sep. 22, 2017

(51) Int. Cl. B25B 13/46; B25B 23/00

(52) U.S. Cl. CPC B25B 13/463; B25B 23/0007

(57) ABSTRACT

A ratchet wrench includes a head having a first hole and second hole defined through the top and the bottom of the head. The second hole communicates with the inner periphery of the first hole. A ratchet wheel and a pawl are respectively located in the first and second holes. The pawl is engaged with the ratchet wheel. A top recessed area and a bottom recessed area are respectively defined in the top and the bottom of the head. Two top caps are engaged with the top recessed area, and two bottom caps are engaged with the bottom recessed area. A top clip and a bottom clip are respectively engaged with the top and bottom of the ratchet wheel. The manufacturing and installation of the ratchet wrench are easy.

### FIELDS OF THE INVENTION

The present invention is a Continuation-In-Part application of applicant's former patent application with the application Ser. No. 15/424,764 filed on Feb. 3, 2017, Ser. No. 15/424,761 filed on Feb. 3, 2017, Ser. No. 15/450,023 filed on Mar. 5, 2017 and Ser. No. 15/450,021 filed on Mar. 5, 2017.

### BACKGROUND OF THE INVENTION

### Descriptions of Related Art

The conventional ratchet wrench known to applicant is disclosed in U.S. Pat. No. 6,862,955 and comprises a circular opening including an annular first groove having a diameter larger than that of the circular opening, and an annular second groove formed at an axial end of the first groove. The second groove has a diameter larger than that of the first groove. An internal crescent cavity is disposed adjacent a handle and in communication with the first groove. A positioning mechanism includes a ring rested on a shoulder formed by the circular opening and the first groove. A flat portion extends from the ring to rest on the cavity, and a spring is anchored at another portion extended from the ring normal to said flat portion to urge against a wall of the cavity. A pawl element is disposed in the cavity. The pawl element includes a pawl section at one side and a bent portion at another side. The bent portion is urged by the spring to lean against the wall of the cavity. A ring member has an annular recess. A flexible C-ring is put on the recess, and a ratchet wheel mechanism is disposed in the circular opening. The ratchet wheel mechanism includes a central opening having a plurality of projections formed around an inner wall thereof. A projecting ratchet wheel is surrounded by the first groove. The ratchet wheel is maintained to engage with the pawl section by the spring. An upper portion with the ring member are fitted therearound and the recess is flush with the second groove so that the C-ring is adapted to expand to partially insert into the second groove for preventing the ratchet wheel mechanism from disengaging from the circular opening.

It is noted that the first groove has a fixed diameter, and the positioning mechanism has to be cooperated with the shapes of the first groove and the internal crescent cavity so that when the positioning mechanism is installed into the first groove and the internal crescent cavity, the positioning mechanism is moved along an inclined and curved path, and then moved along a horizontal path. This installation is complicated to proceed. Besides, the top and the bottom of the internal crescent cavity are closed, and this means that only T-shaped blade can make the internal crescent cavity. The T-shaped blade enters from the first groove and then cuts and moves toward the internal crescent cavity. The T-shaped blade slightly contacts the inside of the first groove so as to make the internal crescent cavity. The diameter of the shank of the T-shaped blade is restricted by the inside of the first groove, so that the shank of the T-shaped blade is restricted to be small, and which is easily broken. Furthermore, there is a flange on the bottom of the first groove, and the flange restricts the movement of the driller, because the driller can cut off the flange if the driller moves too far. In addition, there is a second groove defined in the inner periphery of the first groove. If the inner diameter of the first groove is larger than 15 mm, it is easily to make the second groove. However, if the inner diameter of the first groove is smaller than 15 mm, it will take a lot of time to make the second groove.

The present invention intends to provide a ratchet wrench which is easily manufactured.

### SUMMARY OF THE INVENTION

The present invention relates to a ratchet wrench and comprises a head having a first hole defined through the top and the bottom of the head. A second hole is defined through the top and the bottom of the head and communicates with the inner periphery of the first hole. The center of the second hole is located within the first hole. The diameter of the second hole is smaller than that of the first hole. A top recessed area is defined in the top of the head and located along the first hole and the second hole. A bottom recessed area is defined in the bottom of the head and located along the first hole and the second hole.

A ratchet wheel is rotatably located in the first hole and has toothed portion defined in the outer periphery thereof. An engaging portion is defined in the central portion of the ratchet wheel. A top flange extends from the top of the ratchet wheel, and a bottom flange extends from the bottom of the ratchet wheel. The top flange has a top groove defined in the outer periphery thereof. The bottom flange has a bottom groove defined in the outer periphery thereof. The top and bottom flanges are respectively located corresponding to the top and bottom recessed areas.

A pawl is rotatably located in the second hole and has an engaging portion defined in the front face thereof. The engaging portion is engaged with the toothed portion. The pawl has a recess defined in one end thereof. Two ring-shaped top caps are overlapped to each other and are engaged with the top recessed area. The bottom one of the two top caps is rested on a top shoulder defined between the top recessed area and the first hole. Each of the two top caps has a protrusion which covers up the second hole in the top of the head. The inner periphery of each of the two top caps is engaged with the top flange. The outer periphery of each of the two top caps is engaged with the inner periphery of the top recessed area.

A top clip is engaged with the top recessed area to restrict the top caps from disengaging from the ratchet wheel. A first ring-shaped bottom cap is engaged with the bottom recessed area and rested on a bottom shoulder defined between the bottom recessed area and the first hole. The first bottom cap has a protrusion which covers up the second dhole in the bottom of the head. The inner periphery of the first bottom cap is engaged with the bottom flange. A restriction protrusion protrudes from the top of the first bottom cap. The restriction protrusion is made by way of pressing from the top of the first bottom cap so that an opening shaped as the restriction protrusion is formed.

A resilient member has the first end thereof engaged with the recess of the pawl, and the second end of the resilient member contacts the restriction protrusion to engage the engaging portion with the toothed portion. A second bottom cap is engaged with the bottom recessed area, and overlapped the first bottom cap. The inner periphery of the second bottom cap is engaged with the bottom flange. The outer periphery of the second bottom cap is shaped as the inner periphery of the bottom recessed area. A bottom clip is located in the bottom recessed area, and the inner periphery of the bottom clip is engaged with the bottom groove to restrict the first bottom cap from disengaging from the ratchet wheel.

The primary object of the present invention is to provide a ratchet wrench, wherein the first hole, the second hole, the top recessed area and the bottom recessed area are shaped so that the manufacturing is easy and the blade is not impeded. The installation and the manufacturing are simple. The restriction protrusion of the first bottom cap is simply pressed out therefrom and which is easily made.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a perspective view to show head of the ratchet wrench of the present invention;

FIG. 3 is a perspective view to show the first bottom cap of the ratchet wrench of the present invention;

FIG. 4 is a perspective view to show the ratchet wrench of the present invention;

FIG. 5 is viewed from the bottom of the head of the ratchet wrench of the present invention, wherein the second bottom cap and the bottom clip are removed;

FIG. 6 is viewed from the top of the head of the ratchet wrench of the present invention;

FIG. 7 is a cross sectional view, taken along line 7-7 in FIG. 6;

FIG. 8 is an enlarged cross sectional view of the circled portion “B” in FIG. 7;

FIG. 9 is an exploded view of the second embodiment of the ratchet wrench of the present invention;

FIG. 10 is an exploded view of the third embodiment of the ratchet wrench of the present invention;

FIG. 11 is a front view of the third embodiment of the ratchet wrench of the present invention;

FIG. 12 is a cross sectional view, taken along line 12-12 in FIG. 11, and

FIG. 13 is an enlarged cross sectional view of the circled portion “B” in FIG. 12.

### DETAILED DESCRIPTION OF THE PREFERRED EMBODIMENT

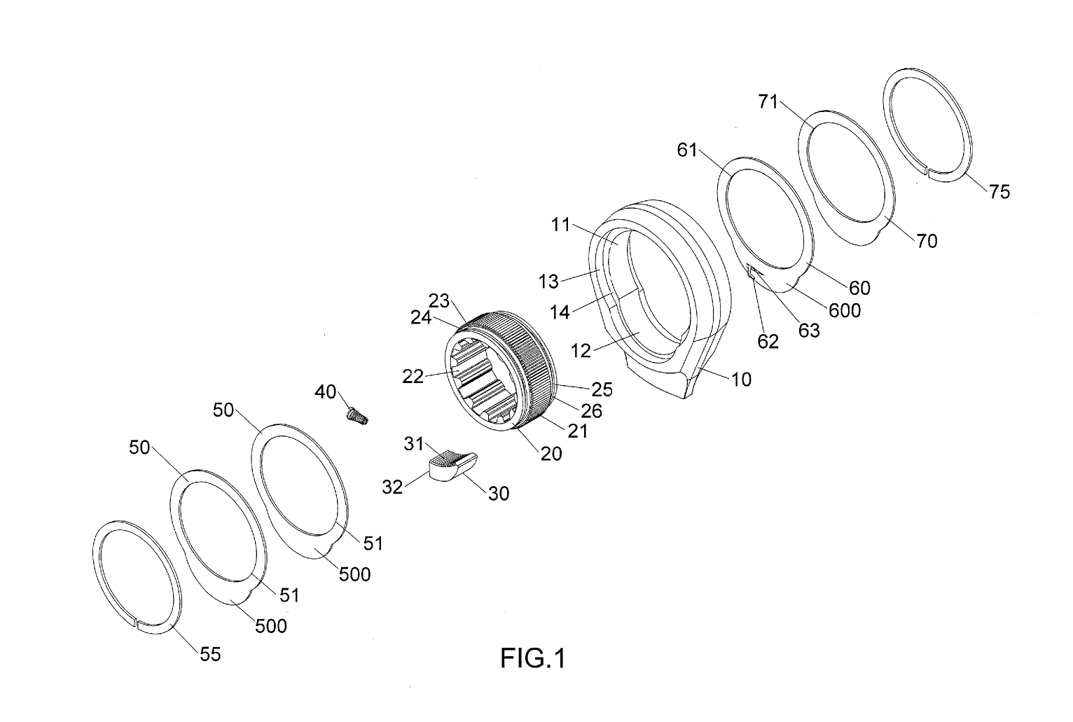

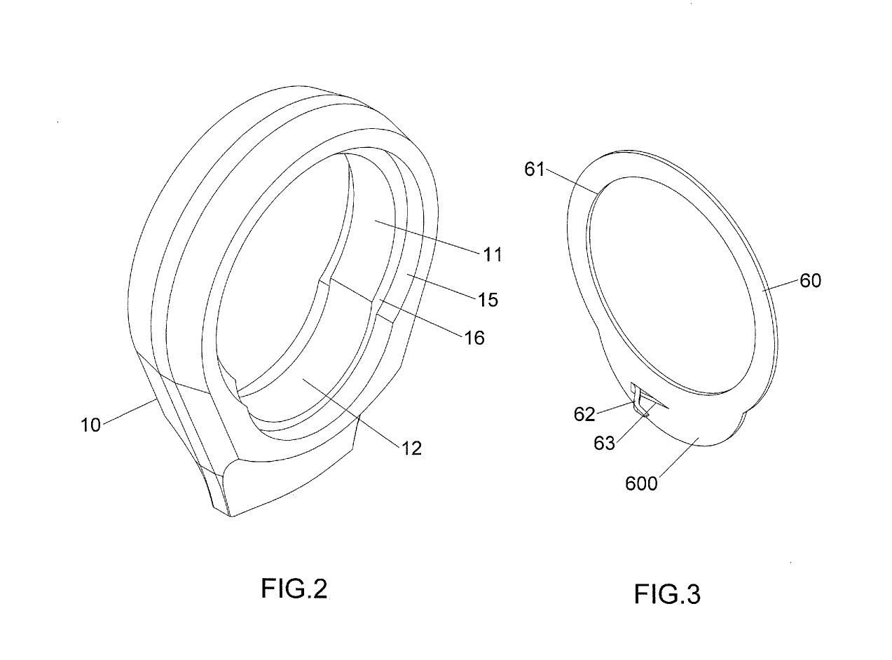

Referring to FIGS. 1 to 8, the ratchet wrench of the present invention comprises a handle and a head 10 which is connected to one end of the handle. The head 10 includes a first hole 11 defined through the top and the bottom of the head 10. A second hole 12 is defined through the top and the bottom of the head 10 and communicates with the inner periphery of the first hole 11. The center of the second hole 12 is located within the first hole 11. The diameter of the second hole 12 is smaller than that of the first hole 11. A top recessed area 13 is defined in the top of the head 10 and located along the first hole 11 and the second hole 12. A bottom recessed area 15 is defined in the bottom of the head 10 and located along the first hole 11 and the second hole 12. The top and bottom recessed areas 13, 15 have the same shape and are located symmetrically relative to the first hole 11.

A ratchet wheel 20 is rotatably located in the first hole 11 and has toothed portion 21 defined in the outer periphery thereof. An engaging portion 22 is defined in the central portion of the ratchet wheel 20. The engaging portion 22 of the ratchet wheel 20 is a polygonal hole or a rectangular protrusion so as to be connected with an object such as a socket or a bolt. A top flange 23 extends from the top of the ratchet wheel 20, and a bottom flange 25 extends from the bottom of the ratchet wheel 20. The top flange 23 has a top groove 24 defined in the outer periphery thereof. The bottom flange 25 has a bottom groove 26 defined in the outer periphery thereof. The top and bottom flanges 23, 25 are respectively located corresponding to the top and bottom recessed areas 13, 15. The top and bottom flanges 23, 25 have the same shape and diameter, and are located symmetrically to the toothed portion 21 of the ratchet wheel 20.

A pawl 30 is rotatably located in the second hole 12 and has an engaging portion 31 defined in the front face thereof. The engaging portion 31 is engaged with the toothed portion 21. The pawl 30 has a recess 32 defined in one end thereof. Two ring-shaped top caps 50 are overlapped to each other and are engaged with the top recessed area 13. The bottom one of the two top caps 50 is rested on a top shoulder 14 defined between the top recessed area 13 and the first hole 11. Each of the two top caps 50 has a protrusion 500 which covers up the second hole 12 in the top of the head 10. The inner periphery 51 of each of the two top caps 50 is engaged with the top flange 23. The outer periphery of each of the two top caps 50 are engaged with the inner periphery of the top recessed area 13. A C-shaped top clip 55 is engaged with the top recessed area 13 and the inner periphery of the top clip 55 is engaged with the top groove 24 so as to restrict the top caps 50 from disengaging from the ratchet wheel 20.

A first ring-shaped bottom cap 60 is engaged with the bottom recessed area 15 and rested on a bottom shoulder 16 defined between the bottom recessed area 15 and the first hole 11. The first bottom cap 60 has a protrusion 600 which covers up the second hole 12 in the bottom of the head 10. The pawl 30 and the resilient member 40 are restricted by the top caps 50 and the first bottom cap 60 so as not to be disengaged from the second hole 12. The inner periphery 61 of the first bottom cap 60 is engaged with the bottom flange 25. A restriction protrusion 62 protrudes from the top of the first bottom cap 60. The restriction protrusion 62 is made by way of pressing from the first bottom cap 60 so that an opening 63 shaped as the restriction protrusion 62 is formed. The shape and size of the opening 63 equals to the shape and size of the restriction protrusion 62.

A resilient member 40 has the first end thereof engaged with the recess 32 of the pawl 30, and the second end of the resilient member 40 contacts the restriction protrusion 62 to engage the engaging portion 31 with the toothed portion 21. The thickness of each of the top caps 50 is equal to the thickness of the first bottom cap 60. A second bottom cap 70 is engaged with the bottom recessed area 15, and overlapped the first bottom cap 60. The inner periphery 71 of the second bottom cap 70 is engaged with the bottom flange 25. The thickness of the second bottom cap 70 is equal to the thickness of the first bottom cap 60. The outer periphery of the second bottom cap 70 is shaped as the inner periphery of the bottom recessed area 15. A C-shaped bottom clip 75 is located in the bottom recessed area 15, and the inner periphery of the bottom clip 75 is engaged with the bottom groove 26 to restrict the first bottom cap 60 from disengaging from the ratchet wheel 20.

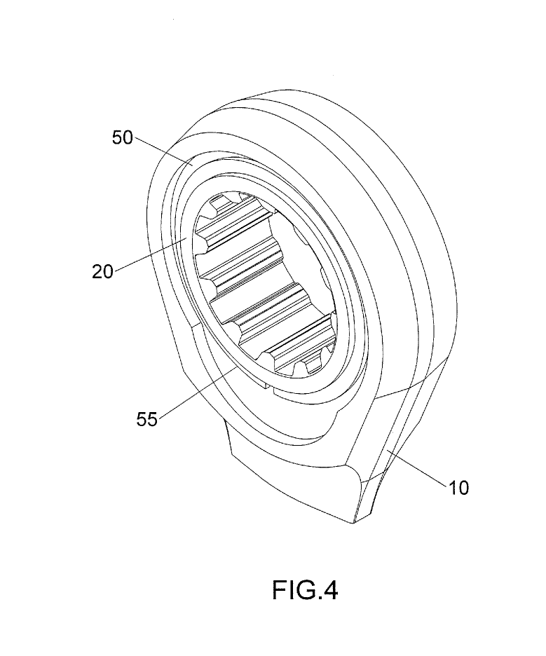

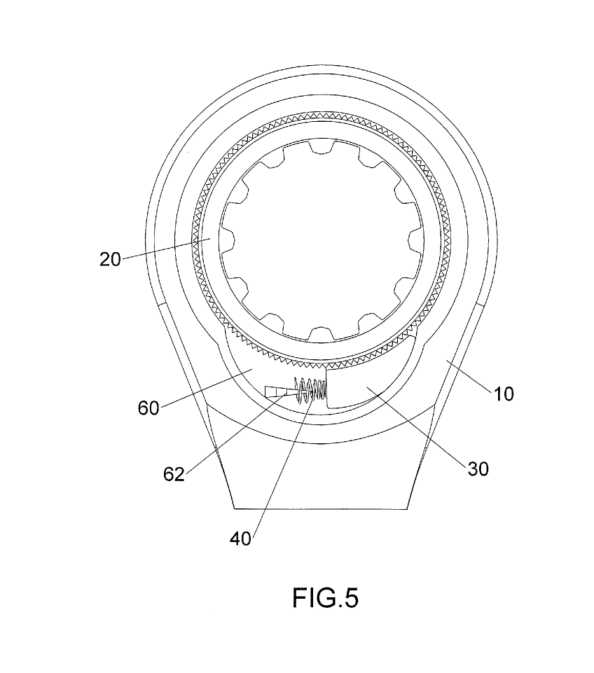

As shown in FIGS. 4 and 5, the ratchet wheel 20 is restricted by the top caps 50, the top clip 55, the first bottom cap 60, the second bottom cap 70 and the bottom clip 75 so as to be restricted in the first hole 11. The top and bottom clips 55, 75 are identical.

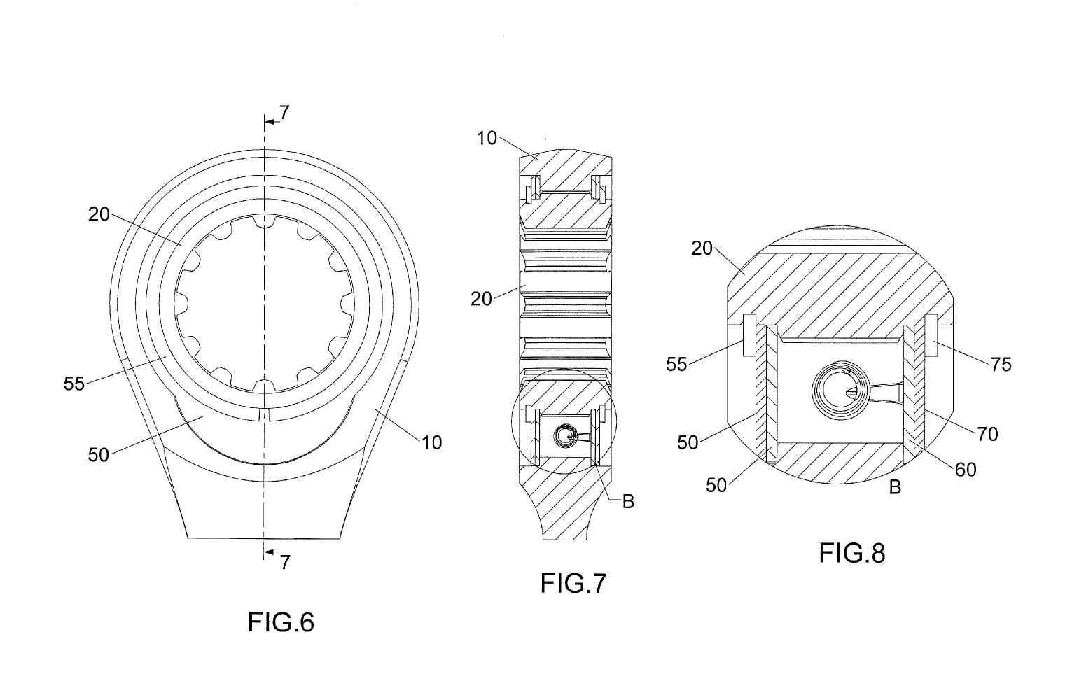

As shown in FIGS. 6 to 8, the two top caps 50 are overlapped and engaged with the top recessed area 13, and are rested on the top shoulder 14. The inner periphery 51 of each of the two top caps 50 is engaged with the top flange 23, and the top clip 55 is located on the top one of the two top caps 50 so that the two top caps 50 do not disengaged from the top recessed area 13. The first bottom cap 60 is engaged with the bottom recessed area 15 and rested on the bottom shoulder 16. The inner periphery 61 of the first bottom cap 60 is engaged with the bottom flange 25. The second bottom cap 70 is engaged with the bottom recessed area 15 and overlapped onto the first bottom cap 60. The inner periphery 71 of the second bottom cap 70 is engaged with the bottom flange 25. The bottom clip 75 is engaged with the bottom recessed area 15 and the bottom groove 26. The bottom clip 75 contacts the second bottom cap 70. The ratchet wheel 20 is restricted in the first hole 11 by the top caps 50, the top clip 55, the first bottom cap 60, the second bottom cap 70 and the bottom clip 75.

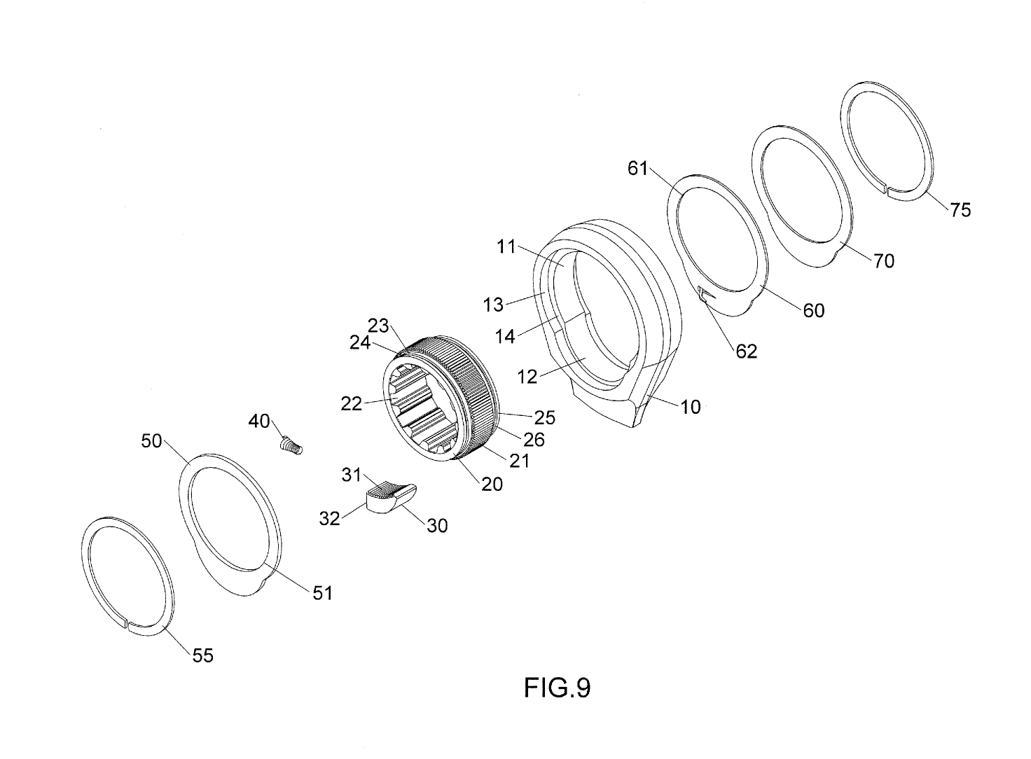

FIG. 9 shows that only one top cap 50 is used, and the thickness of the top cap 50 is equal to the total thickness of the first bottom cap 60 and the second bottom cap 70.

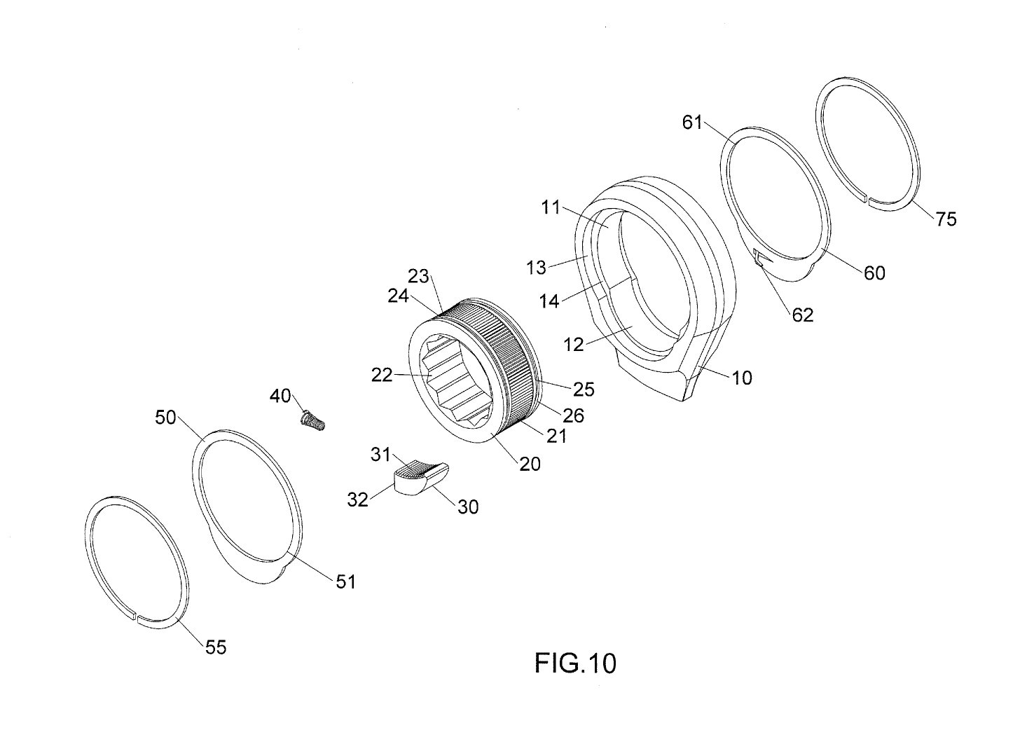

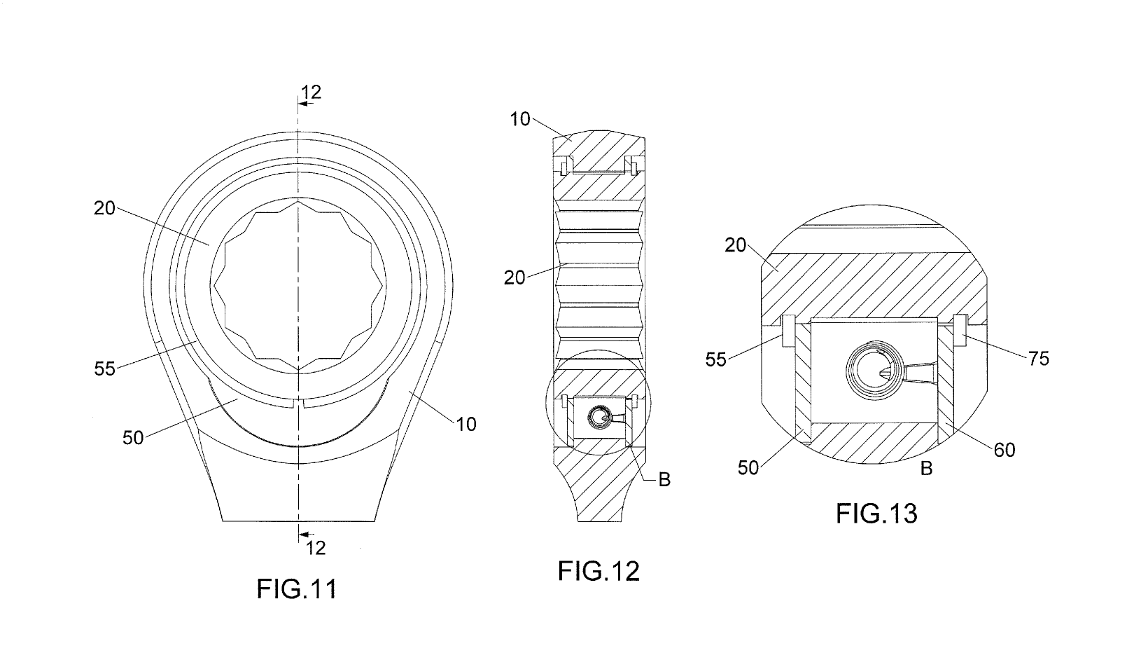

FIGS. 10 to 13 show that the outer periphery of the top flange 23 is larger or equal to that of the toothed portion 21 of the ratchet wheel 20. The outer periphery of the bottom flange 25 is larger than that of the toothed portion 21 of the ratchet wheel 20, and the outer diameter of the bottom flange 25 is equal to that of the top flange 23. Comparing with FIG. 1, FIG. 10 shows the two top caps 50 are formed as one piece, and the first bottom cap 60 and the second bottom cap 70 are formed as one piece as well. The thickness of the one-piece of the two top caps 50 is equal to the thickness of the one-piece of the first bottom cap 60 and the second bottom cap 70.

In another embodiment, the engaging portion 22 can be a rectangular protrusion.

As shown in FIG. 5, the horizontal position of a distal end of the restriction protrusion 62 is lower than that of a central axial line of the recess 32 on a horizontal plane to guide the resilient member 40 to bias the pawl 30 extending at an inclined angle with respect to the horizontal plane.

The advantages of the present invention are that the first and second holes 11, 12 are easily manufactured because they are defined through the top and bottom of the head 10. The first and second holes 11, 12, and the top recessed area 13 and the top shoulder 14 can be made by using the same tool or machine without accumulated tolerance.

The head 10 can be forged with the first and second holes 11, 12, and the top recessed area 13, the top shoulder 14, the bottom recessed area 15 and the bottom shoulder 16 are then pressed in a molding unit. The processes of manufacturing are easy and simplified.

The first bottom cap 60 has the restriction protrusion 62 which is connected with one end of the resilient member 40 so that the resilient member 40 does not disengaged from the pawl 30.

The restriction protrusion 62 is easily made and machined.

The ratchet wheel 20 is restricted in the first hole 11 by the top caps 50, the top clip 55, the first bottom cap 60, the second bottom cap 70 and the bottom clip 75. The use of the top and bottom clips 55, 75 allow the users to easily assembly or dis-assembly the wrench.

The ratchet wheel 20 is well supported at the two ends thereof by the engagement between the inner peripheries 51 of the two top caps 50 with the top flange 23, and by the engagement between the inner peripheries 61, 71 of the first and second bottom caps 60, 70 with the bottom flange 25.

When replacing the ratchet wheel 20, the users simply remove the top clip 55 or the bottom clip 75 to easily remove eh ratchet wheel 20 from the first hole 11.

While we have shown and described the embodiment in accordance with the present invention, it should be clear to those skilled in the art that further embodiments may be made without departing from the scope of the present invention.

What is claimed is:

1. A ratchet wrench comprising:
a head having a first hole defined through a top and a bottom of the head, a second hole defined through the top and the bottom of the head and communicating with an inner periphery of the first hole, a center of the second hole located within the first hole, a diameter of the second hole being smaller than that of the first hole, a top recessed area defined in the top of the head and located along the first hole and the second hole, a bottom recessed area defined in the bottom of the head and located along the first hole and the second hole;
a ratchet wheel rotatably located in the first hole and having toothed portion defined in an outer periphery thereof, an engaging portion defined in a central portion of the ratchet wheel, a top flange extending from a top of the ratchet wheel, a bottom flange extending from a bottom of the ratchet wheel, the top flange having a top groove defined in an outer periphery thereof, the bottom flange having a bottom groove defined in an outer periphery thereof, the top and bottom flanges respectively located corresponding to the top and bottom recessed areas;
a pawl rotatably located in the second hole and having an engaging portion defined in a front face thereof, the engaging portion engaged with the toothed portion, the pawl having a recess defined in one end thereof;
two ring-shaped top caps overlapped to each other and being engaged with the top recessed area, a bottom one of the two top caps rested on a top shoulder defined between the top recessed area and the first hole, each of the two top caps having a protrusion which covers up the second hole in the top of the head, an inner periphery of each of the two top caps engaged with the top flange, an outer periphery of each of the two top caps engaged with an inner periphery of the top recessed area;
a top clip engaged with the top recessed area to restrict the top caps from disengaging from the ratchet wheel;
a first ring-shaped bottom cap engaged with the bottom recessed area and rested on a bottom shoulder defined between the bottom recessed area and the first hole, the first bottom cap having a protrusion which covers up the second dhole in the bottom of the head, an inner periphery of the first bottom cap engaged with the bottom flange, wherein a restriction protrusion protruding from a top of the first bottom cap, the restriction protrusion being pressed from the first bottom cap so that an opening shaped as the restriction protrusion is formed;
a resilient member having a first end engaged with the recess of the pawl, and a second end contacting the restriction protrusion to engage the engaging portion with the toothed portion;
a second bottom cap engaged with the bottom recessed area, and overlapped the first bottom cap, an inner periphery of the second bottom cap engaged with the bottom flange, an outer periphery of the second bottom cap being shaped as the inner periphery of the bottom recessed area, and
a bottom clip located in the bottom recessed area and an inner periphery of the bottom clip engaged with the bottom groove to restrict the first bottom cap from disengaging from the ratchet wheel.

2. The ratchet wrench as claimed in claim 1, wherein the engaging portion of the ratchet wheel is a polygonal hole or a rectangular protrusion.

3. The ratchet wrench as claimed in claim 1, wherein an outer periphery of the top flange is smaller than that of the toothed portion of the ratchet wheel.

4. The ratchet wrench as claimed in claim 1, wherein an outer periphery of the bottom flange is smaller than that of the toothed portion of the ratchet wheel.

5. The ratchet wrench as claimed in claim 1, wherein an outer diameter of the top flange is equal to an outer diameter of the bottom flange, the top and bottom flanges are located symmetrically the toothed portion of the ratchet wheel, the top and bottom recessed areas have the same shape and are located symmetrically relative to the first hole.

6. The ratchet wrench as claimed in claim 1, wherein the top clip and the bottom clip each are a C-shaped clip.

7. The ratchet wrench as claimed in claim 1, wherein the two top caps are formed as one piece.

8. The ratchet wrench as claimed in claim 1, wherein an outer diameter of the top flange is larger or equal to that of the toothed portion of the ratchet wheel.

9. The ratchet wrench as claimed in claim 1, wherein an outer periphery of the bottom flange is larger than that of the toothed portion of the ratchet wheel, the outer diameter of the bottom flange is equal to that of the top flange.

10. The ratchet wrench as claimed in claim 1, wherein a thickness of each of the top caps is equal to a thickness of the first bottom cap, a thickness of the second bottom cap is equal to the thickness of the first bottom cap.

11. The ratchet wrench as claimed in claim 1, wherein a horizontal position of a distal end of the restriction protrusion is lower than that of a central axial line of the recess on a horizontal plane to guide the resilient member to bias the pawl extending at an inclined angle with respect to the horizontal plane.
